(19) United States
(12) Patent Application Publication
(10) Pub. No.: US 2026/0253572 A1
(43) Pub. Date: Aug. 27, 2026

(54) ACTIVE NOISE REDUCTION DEVICE

(71) Applicant: HONDA MOTOR CO., LTD., Tokyo (JP)

(72) Inventors: Xun WANG, Saitama (JP); Toshio INOUE, Saitama (JP); Takuma MAESAKA, Saitama (JP)

(21) Appl. No.: 19/541,935

(22) Filed: Feb. 17, 2026

(30) Foreign Application Priority Data
Feb. 27, 2025 (JP) 2025-029887

(51) Int. Cl. G10K 11/178

(52) U.S. Cl. CPC G10K 11/17825; G10K 11/17854; G10K 11/17857; G10K 11/17881

(57) ABSTRACT

An active noise reduction device used for a mobile body includes a canceling sound outputter configured to output a canceling sound for canceling a noise, and a controller configured to control the canceling sound outputter. The controller includes at least one filter that can be adaptively updated, and the controller is configured to change a processing amount in an adaptive update process of the filter according to a speed of the mobile body.

### TECHNICAL FIELD

The present invention relates to an active noise reduction device.

### BACKGROUND ART

Conventionally, a known active noise reduction device reduces a noise by causing a canceling sound in the opposite phase to the noise to interfere with the noise. For example, JP2019-81396A discloses an active noise reduction device configured to stop the generation of a canceling sound by the control to decrease the signal level of a canceling signal (a signal for generating the canceling sound) in a case where the speed of a mobile body is lower than a threshold.

However, if the generation of the canceling sound is stopped in a case where the speed of the mobile body is lower than the threshold as described above, the noise reduction performance of the active noise reduction device may not be exerted, and the noise may not be reduced stably and effectively.

### SUMMARY OF THE INVENTION

In view of the above background, an object of the present invention is to provide an active noise reduction device that can stably and effectively reduce the noise.

To achieve such an object, one aspect of the present invention provides an active noise reduction device used for a mobile body, the active noise reduction device comprising: a canceling sound outputter configured to output a canceling sound for canceling a noise; and a controller configured to control the canceling sound outputter, wherein the controller includes at least one filter that can be adaptively updated, and the controller is configured to change a processing amount in an adaptive update process of the filter according to a speed of the mobile body.

Thus, according to the above aspect, it is possible to provide an active noise reduction device that can stably and effectively reduce the noise.

### BRIEF DESCRIPTION OF THE DRAWING(S)

FIG. 1 is a schematic diagram showing a vehicle to which an active noise reduction device according to an embodiment is applied;

FIG. 2 is a block diagram showing the active noise reduction device according to the embodiment;

FIG. 3 is a flowchart showing an execution example of processing amount changing control according to the embodiment;

FIG. 4 is a graph showing a setting line of a μ table according to the embodiment; and

FIG. 5 is a graph showing a setting line of an η table according to the embodiment.

### DETAILED DESCRIPTION OF THE INVENTION

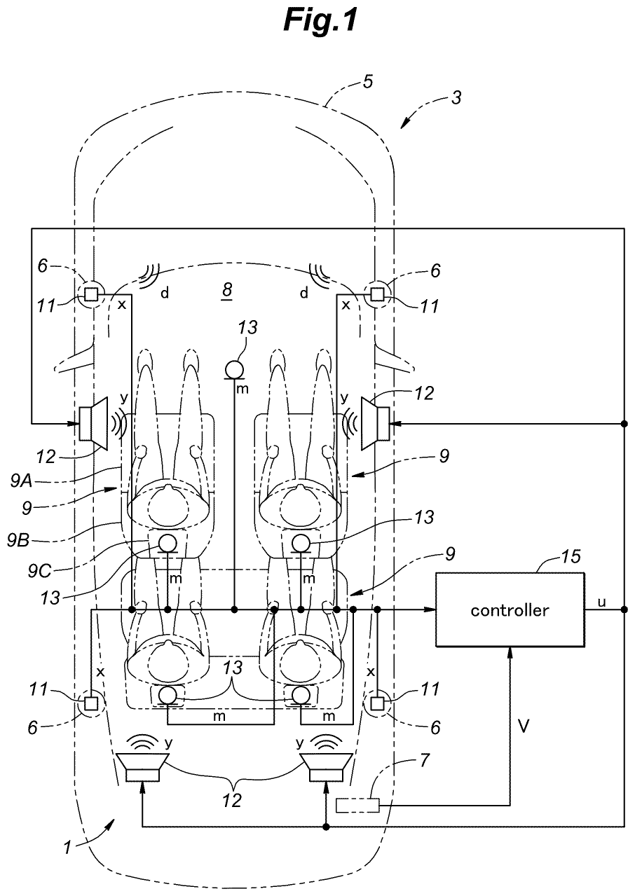

In the following, with reference to FIGS. 1 to 5, an active noise reduction device 1 (hereinafter abbreviated as “the noise reduction device 1”) according to an embodiment will be described. In this specification, “\hat{ }” (circumflex) next to various symbols represents an identification value or an estimation value. “\hat{ }” is arranged above various symbols in the drawings and formulas, but is arranged after various symbols in the following description. “AU” shown in some of the drawings represents an adaptive update.

### <Vehicle 3>

FIG. 1 is a schematic diagram showing a vehicle 3 (an example of a mobile body) to which the noise reduction device 1 is applied. The vehicle 3 includes a vehicle body 5, a plurality of wheels (not shown) arranged below the vehicle body 5, a plurality of suspensions 6 arranged between the vehicle body 5 and the plurality of wheels, and a vehicle speed sensor 7 configured to detect the speed of the vehicle 3 (hereinafter referred to as “the vehicle speed V”). A vehicle cabin 8 is formed inside the vehicle body 5. The vehicle cabin 8 is provided with a plurality of occupant seats 9. Each occupant seat 9 includes a seat cushion 9A, a seat back 9B arranged above and behind the seat cushion 9A, and a headrest 9C fixed to the upper end of the seat back 9B.

### <Noise Reduction Device 1>

With reference to FIG. 1, the noise reduction device 1 is an ANC (Active Noise Control) device for reducing a noise d generated within the vehicle cabin 8 of the vehicle 3. More specifically, the noise reduction device 1 generates a canceling sound y that is in the opposite phase to the noise d, and reduces the noise d by causing the generated canceling sound y to interfere with the noise d.

The noise reduction device 1 includes a plurality of acceleration sensors 11 each configured to generate an acceleration signal x based on the noise d, a plurality of speakers 12 (an example of canceling sound outputters) each configured to output the canceling sound y for canceling the noise d, a plurality of microphones 13 each configured to generate a microphone signal m based on the noise d, and a controller 15 configured to control the plurality of speakers 12 based on the acceleration signal x and the microphone signal m.

### <Acceleration Sensor 11>

With reference to FIG. 1, each acceleration sensor 11 is installed in the corresponding suspension 6. The acceleration sensor 11 detects the acceleration of the suspension 6 according to the noise d, and generates the acceleration signal x according to the acceleration of the suspension 6. The acceleration signal x is used as a reference signal corresponding to the noise d.

### <Speaker 12>

With reference to FIG. 1, each speaker 12 is installed in a portion (for example, a door on the side of the occupant seat 9 or a space behind the occupant seat 9) of the vehicle 3 other than the occupant seat 9. In another embodiment, the speaker 12 may be installed in the occupant seat 9 (for example, the headrest 9C of the occupant seat 9).

### <Microphone 13>

With reference to FIG. 1, each microphone 13 is installed in the headrest 9C of the occupant seat 9 or the vicinity of a noise source. In another embodiment, the microphone 13 may be installed in a portion (for example, a ceiling above the occupant seat 9) of the vehicle 3 other than the occupant seat 9 or the vicinity of a noise source.

The microphone 13 is simultaneously used as a microphone configured to generate an error signal e corresponding to an error between the noise d and the canceling sound y, and as a microphone configured to generate a reference signal r corresponding to the noise d. In other words, the microphone signal m is simultaneously used as the error signal e and the reference signal r. For example, in a control channel whose control target is the speaker 12 adjacent to the driver's seat, the microphone 13 installed in the driver's seat generates the error signal e, and the microphone 13 installed in a seat other than the driver's seat or the vicinity of the noise source generates the reference signal r. By contrast, in a control channel whose control target is the speaker 12 adjacent to the passenger seat, the microphone 13 installed in the passenger seat generates the error signal e, and the microphone 13 installed in a seat other than the passenger seat or the vicinity of the noise source generates the reference signal r. Hereinafter, the microphone 13 configured to generate the error signal e will be referred to as “the error microphone 13e,” and the microphone 13 configured to generate the reference signal r will be referred to as “the reference microphone 13r”.

### <Controller 15>

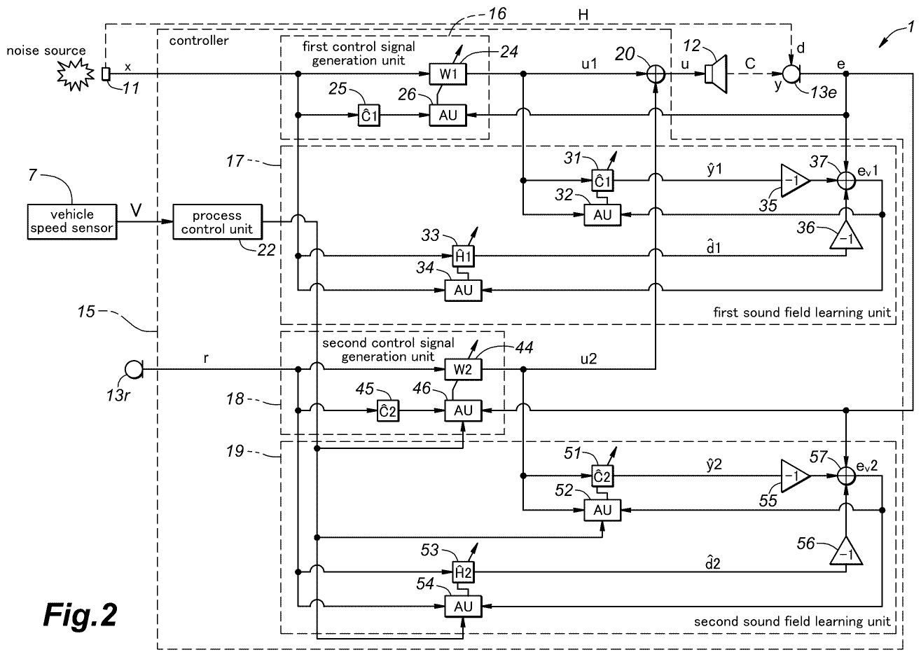

With reference to FIG. 2, the controller 15 is composed of a computer having an arithmetic processing unit (a processor such as a CPU or an MPU) and a storage unit (memory such as a ROM or a RAM). The controller 15 may be composed of a single piece of hardware, or may be composed of a unit including plural pieces of hardware.

The controller 15 includes, as the functional components thereof, a plurality of first control signal generation units 16 (an example of a first controller), a plurality of first sound field learning units 17 (another example of the first controller), a plurality of second control signal generation units 18 (an example of a second controller), a plurality of second sound field learning units 19 (another example of the second controller), a control signal adding unit 20, and a process control unit 22. The number of first control signal generation units 16 and the number of first sound field learning units 17 correspond to the number of acceleration sensors 11. The number of second control signal generation units 18 and the number of second sound field learning units 19 correspond to the number of reference microphones 13r. In FIG. 2, only one of the first control signal generation units 16, only one of the first sound field learning units 17, only one of the second control signal generation units 18, and only one of the second sound field learning units 19 are shown.

### <First Control Signal Generation Unit 16>

The acceleration signal x (reference signal) from the acceleration sensor 11 is input to each first control signal generation unit 16 of the controller 15. Each first control signal generation unit 16 includes a control filter unit 24, a reference signal correction unit 25, and a control update unit 26.

The control filter unit 24 includes a control filter W1. The control filter W1 is composed of an FIR filter (Finite Impulse Response filter). In another embodiment, the control filter W1 may be composed of a SAN filter (Single-frequency Adaptive Notch filter) and the like. The control filter unit 24 generates a first control signal u1 by executing a filtering process on the acceleration signal x (reference signal) using the control filter W1. The control filter unit 24 outputs the generated first control signal u1 to the first sound field learning unit 17 and the control signal adding unit 20.

The reference signal correction unit 25 includes a secondary path filter C\hat{ }1. The secondary path filter C\hat{ }1 is a filter that represents an estimation value of a transfer function C of a secondary path from the speaker 12 to the error microphone 13e. The secondary path filter C\hat{ }1 is composed of an FIR filter. In another embodiment, the secondary path filter C\hat{ }1 may be composed of a SAN filter and the like. The reference signal correction unit 25 corrects the acceleration signal x by executing a filtering process on the acceleration signal x (reference signal) using the secondary path filter C\hat{ }1. The reference signal correction unit 25 outputs the corrected acceleration signal x to the control update unit 26.

The control update unit 26 adaptively updates the control filter W1 using an adaptive algorithm such as an LMS algorithm (Least Mean Square algorithm). More specifically, the control update unit 26 adaptively updates the control filter W1 using the following formula (1) so that the error signal e output from the error microphone 13e is minimized.

$$W 1 ( t + 1 ) = η W 1 ( t ) - μ e ( t ) ( x ( t ) * \hat{C} 1 ( t ) ) \qquad ( 1 )$$

W1(t+1) in the above formula (1) represents the update value of the control filter W1 (the value of the control filter W1 after the adaptive update thereof), and W1(t) in the above formula (1) represents the current value of the control filter W1 (the value of the control filter W1 before the adaptive update thereof). In the above formula (1), e(t), x(t), and C\hat{ }1(t) represent the current value of the error signal e, the current value of the acceleration signal x, and the current value of the secondary path filter C\hat{ }1, respectively. “1” in the above formula (1) represents a parameter (hereinafter referred to as “the forgetting factor l”) for attenuating the control filter W1 and adjusting the magnitude of the first control signal u1 (u1=x*W1). As the forgetting factor η increases, the first control signal u1 and the canceling sound y increase. The forgetting factor η is set to a value between 0 and 1. “a” in the above formula (1) is a parameter (hereinafter referred to as “the step size parameter a”) for adjusting the magnitude of the update amount of the control filter W1 in each adaptive update of the control filter W1. As the step size parameter increases, the update amount of the control filter W1 increases. The step size parameter is set to a small positive number.

### <First Sound Field Learning Unit 17>

The acceleration signal x (reference signal) from the acceleration sensor 11 is input to each first sound field learning unit 17 of the controller 15. Each first sound field learning unit 17 includes a canceling sound estimation signal generation unit 31, a secondary path update unit 32, a noise estimation signal generation unit 33, a primary path update unit 34, a canceling sound estimation signal reversing unit 35, a noise estimation signal reversing unit 36, and a virtual error signal generation unit 37.

The canceling sound estimation signal generation unit 31, like the reference signal correction unit 25, includes the secondary path filter C\hat{ }1. The canceling sound estimation signal generation unit 31 generates a first canceling sound estimation signal y\hat{ }1 that represents an estimation value of the canceling sound y by executing a filtering process on the first control signal u1 using the secondary path filter C\hat{ }1. The canceling sound estimation signal generation unit 31 outputs the generated first canceling sound estimation signal y\hat{ }1 to the canceling sound estimation signal reversing unit 35.

The secondary path update unit 32 adaptively updates the secondary path filter C\hat{ }1 of the canceling sound estimation signal generation unit 31 using an adaptive algorithm such as an LMS algorithm. More specifically, the secondary path update unit 32 adaptively updates the secondary path filter C\hat{ }1 using the following formula (2) so that a first virtual error signal eᵥ1 (details will be described later) output from the virtual error signal generation unit 37 is minimized.

$$\hat{C} 1 ( t + 1 ) = η \hat{C} 1 ( t ) + μ {e}_{v} 1 ( t ) u 1 ( t ) \qquad ( 2 )$$

C\hat{ }2(t+1) in the above formula (2) represents the update value of the secondary path filter \hat{ }1 (the value of the secondary path filter C\hat{ }1 after the adaptive update thereof), and C\hat{ }1(t) in the above formula (2) represents the current value of the secondary path filter C\hat{ }1 (the value of the secondary path filter C\hat{ }1 before the adaptive update thereof). In the above formula (2), eᵥ1(t) and u1(t) represent the current value of the first virtual error signal eᵥ1 and the current value of the first control signal u1, respectively. In the above formula (2), η and μ represent the forgetting factor η and the step size parameter μ, respectively.

Further, when the secondary path update unit 32 updates the secondary path filter C\hat{ }1 of the canceling sound estimation signal generation unit 31 as described above, the updated secondary path filter C\hat{ }1 may be output to the reference signal correction unit 25, and the secondary path filter C\hat{ }1 of the reference signal correction unit 25 may be updated.

The noise estimation signal generation unit 33 includes a primary path filter H\hat{ }1. The primary path filter H\hat{ }1 is a filter that represents an estimation value of a transfer function H of a primary path from the noise source to the error microphone 13e. The primary path filter H\hat{ }1 is composed of an FIR filter, for example. In another embodiment, the primary path filter H\hat{ }1 may be composed of a SAN filter and the like. The noise estimation signal generation unit 33 generates a first noise estimation signal d\hat{ }1 that represents an estimation value of the noise d by executing a filtering process on the acceleration signal x (reference signal) using the primary path filter H\hat{ }1. The noise estimation signal generation unit 33 outputs the generated first noise estimation signal d\hat{ }1 to the noise estimation signal reversing unit 36.

The primary path update unit 34 adaptively updates the primary path filter H\hat{ }1 using an adaptive algorithm such as an LMS algorithm. More specifically, the primary path update unit 34 adaptively updates the primary path filter H\hat{ }1 using the following formula (3) so that the first virtual error signal eᵥ1 (details will be described later) output from the virtual error signal generation unit 37 is minimized.

$$\hat{H} 1 ( t + 1 ) = η \hat{H} 1 ( t ) + μ {e}_{v} 1 ( t ) x ( t ) \qquad ( 3 )$$

H\hat{ }1(t+1) in the above formula (3) represents the update value of the primary path filter H\hat{ }1 (the value of the primary path filter H\hat{ }1 after the adaptive update thereof), and H\hat{ }1(t) in the above formula (3) represents the current value of the primary path filter H\hat{ }1 (the value of the primary path filter H\hat{ }1 before the adaptive update thereof). In the above formula (3), eᵥ1(t) and x(t) represent the current value of the first virtual error signal eᵥ1 and the current value of the acceleration signal x, respectively. In the above formula (3), η and μ represent the forgetting factor η and the step size parameter μ, respectively.

The canceling sound estimation signal reversing unit 35 reverses the polarity of the first canceling sound estimation signal y\hat{ }1 output from the canceling sound estimation signal generation unit 31. The canceling sound estimation signal reversing unit 35 outputs the first canceling sound estimation signal y\hat{ }1 with the polarity reversed to the virtual error signal generation unit 37.

The noise estimation signal reversing unit 36 reverses the polarity of the first noise estimation signal d\hat{ }1 output from the noise estimation signal generation unit 33. The noise estimation signal reversing unit 36 outputs the first noise estimation signal d\hat{ }1 with the polarity reversed to the virtual error signal generation unit 37.

The virtual error signal generation unit 37 generates the first virtual error signal eᵥ1 by adding together the error signal e output from the error microphone 13e, the first canceling sound estimation signal y\hat{ }1 that has passed through the canceling sound estimation signal reversing unit 35, and the first noise estimation signal d\hat{ }1 that has passed through the noise estimation signal reversing unit 36. The virtual error signal generation unit 37 outputs the generated first virtual error signal eᵥ1 to the secondary path update unit 32 and the primary path update unit 34.

### <Second Control Signal Generation Unit 18>

The reference signal r from the reference microphone 13r is input to each second control signal generation unit 18 of the controller 15. Each second control signal generation unit 18 includes a control filter unit 44, a reference signal correction unit 45, and a control update unit 46. The components of the second control signal generation unit 18 are similar to the components of the first control signal generation unit 16. Hereinafter, the second control signal generation unit 18 will be described, focusing only on the differences from the first control signal generation unit 16.

The control filter unit 44 generates a second control signal u2 by executing a filtering process on the reference signal r (the reference signal output from the reference microphone 13r) using a control filter W2. The control filter unit 44 outputs the generated second control signal u2 to the second sound field learning unit 19 and the control signal adding unit 20.

The reference signal correction unit 45 corrects the reference signal r (the reference signal output from the reference microphone 13r) by executing a filtering process on the reference signal r using a secondary path filter C\hat{ }2. The reference signal correction unit 45 outputs the corrected reference signal r to the control update unit 46.

The control update unit 46 adaptively updates the control filter W2 using the following formula (4) so that the error signal e output from the error microphone 13e is minimized.

$$W 2 ( t + 1 ) = η W 2 ( t ) - μ e ( t ) ( r ( t ) * \hat{C} 2 ( t ) ) \qquad ( 4 )$$

### <Second Sound Field Learning Unit 19>

The reference signal r from the reference microphone 13r is input to each second sound field learning unit 19 of the controller 15. Each second sound field learning unit 19 includes a canceling sound estimation signal generation unit 51, a secondary path update unit 52, a noise estimation signal generation unit 53, a primary path update unit 54, a canceling sound estimation signal reversing unit 55, a noise estimation signal reversing unit 56, and a virtual error signal generation unit 57. The components of the second sound field learning unit 19 are similar to the components of the first sound field learning unit 17. Hereinafter, the second sound field learning unit 19 will be described, focusing only on the differences from the first sound field learning unit 17.

The canceling sound estimation signal generation unit 51 generate a second canceling sound estimation signal y\hat{ }2 that represents an estimation value of the canceling sound y by executing a filtering process on the second control signal u2 using the secondary path filter C\hat{ }2. The canceling sound estimation signal generation unit 51 outputs the generated second canceling sound estimation signal \hat{ }2 to the canceling sound estimation signal reversing unit 55.

The secondary path update unit 52 adaptively updates the secondary path filter \hat{ }2 using the following formula (5) so that a second virtual error signal eᵥ2 (details will be described later) output from the virtual error signal generation unit 57 is minimized.

$$\hat{C} 2 ( t + 1 ) = η \hat{C} 2 ( t ) + μ {e}_{v} 2 ( t ) u 2 ( t ) \qquad ( 5 )$$

The noise estimation signal generation unit 53 generates a second noise estimation signal d\hat{ }2 that represents an estimation value of the noise d by executing a filtering process on the reference signal r (the reference signal output from the reference microphone 13r) using a primary path filter H\hat{ }2. The noise estimation signal generation unit 53 outputs the generated second noise estimation signal d\hat{ }2 to the noise estimation signal reversing unit 56.

The primary path update unit 54 adaptively updates the primary path filter H\hat{ }2 using the following formula (6) so that the second virtual error signal eᵥ2 (details will be described later) output from the virtual error signal generation unit 57 is minimized.

$$\hat{H} 2 ( t + 1 ) = η \hat{H} 2 ( t ) + μ {e}_{v} 2 ( t ) r ( t ) \qquad ( 6 )$$

The canceling sound estimation signal reversing unit 55 reverses the polarity of the second canceling sound estimation signal y\hat{ }2 output from the canceling sound estimation signal generation unit 51. The canceling sound estimation signal reversing unit 55 outputs the second canceling sound estimation signal y\hat{ }2 with the polarity reversed to the virtual error signal generation unit 57.

The noise estimation signal reversing unit 56 reverses the polarity of the second noise estimation signal d\hat{ }2 output from the noise estimation signal generation unit 53. The noise estimation signal reversing unit 56 outputs the second noise estimation signal d\hat{ }2 with the polarity reversed to the virtual error signal generation unit 57.

The virtual error signal generation unit 57 generates the second virtual error signal eᵥ2 by adding together the error signal e output from the error microphone 13e, the second canceling sound estimation signal y\hat{ }2 that has passed through the canceling sound estimation signal reversing unit 55, and the second noise estimation signal d\hat{ }2 that has passed through the noise estimation signal reversing unit 56. The virtual error signal generation unit 57 outputs the generated second virtual error signal eᵥ2 to the secondary path update unit 52 and the primary path update unit 54.

### <Control Signal Adding Unit 20>

The control signal adding unit 20 of the controller 15 generates a control signal u for controlling the speaker 12 by adding together the first control signal u1 output from each of the first control signal generation units 16 and the second control signal u2 output from each of the second control signal generation units 18. The control signal adding unit 20 outputs the generated control signal u to the speaker 12. When the control signal u is input to the speaker 12, the speaker 12 generates the canceling sound y according to the magnitude of the control signal u.

### <Process Control Unit 22>

With reference to FIG. 2, the process control unit 22 of the controller 15 controls an adaptive update process in the second control signal generation unit 18 and the second sound field learning unit 19 by transmitting the prescribed signals (for example, the signals related to the step size parameter μ and the forgetting factor η) to the control update unit 46, the secondary path update unit 52, and the primary path update unit 54. The adaptive update process is a process to adaptively update the control filter W2, the secondary path filter C\hat{ }2, and the primary path filter H\hat{ }2 (hereinafter referred to as “the adaptive update filters W2, C\hat{ }2, H\hat{ }2).

The process control unit 22 acquires the vehicle speed V from the vehicle speed sensor 7 via a CAN (Controller Area Network). The process control unit 22 changes the processing amount in the adaptive update process according to the vehicle speed V. Hereinafter, the control for changing the processing amount in the adaptive update process according to the vehicle speed V will be referred to as “the processing amount changing control”.

### <Execution Example of the Processing Amount Changing Control>

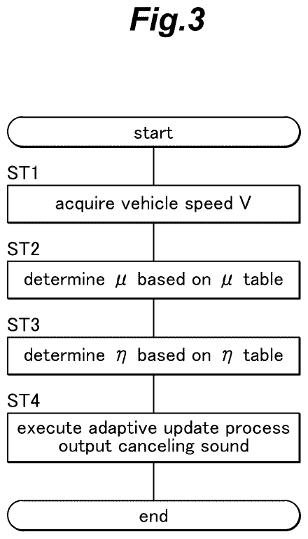

With reference to FIG. 3, when the processing amount changing control is started, the process control unit 22 acquires the current vehicle speed V from the vehicle speed sensor 7 via the CAN (step ST1).

Next, the process control unit 22 determines the step size parameter μ based on the vehicle speed V acquired from the vehicle speed sensor 7 and a μ table showing the relationship between the vehicle speed V and the step size parameter μ (step ST2). The table will be described in detail later.

Further, the process control unit 22 determines the forgetting factor η based on the vehicle speed V acquired from the vehicle speed sensor 7 and an η table showing the relationship between the vehicle speed V and the forgetting factor η (step ST3). The η table will be described in detail later.

Next, the process control unit 22 adaptively updates the adaptive update filters W2, C\hat{ }2, H\hat{ }2 by executing the adaptive update process using the step size parameter μ and the forgetting factor η determined in steps ST2 and ST3 (see the above formulas (4) to (6)). Further, the process control unit 22 causes the speaker 12 to output the canceling sound y using the control filter W2 adaptively updated by the adaptive update process (step ST4).

### <μ Table>

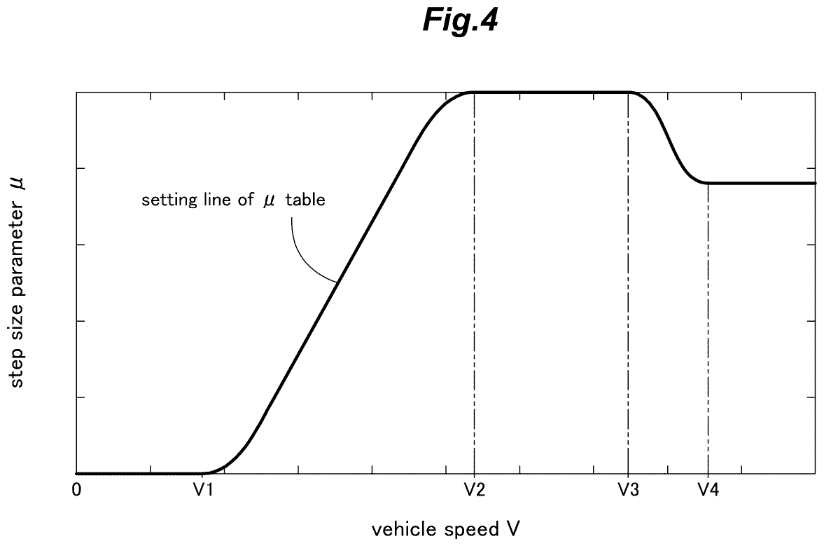

With reference to FIG. 4, in a case where the vehicle speed V is less than a speed V1 in the μ table, the step size parameter μ is kept at 0. Accordingly, in a case where the vehicle speed V is less than the speed V1, the adaptive update process is stopped.

In a case where the vehicle speed V is equal to or greater than the speed V1 and less than a speed V2 (an example of a first speed) that is higher than the speed V1 in the μ table, the step size parameter μ becomes continuously larger as the vehicle speed V increases. Accordingly, when the vehicle speed V increases from a value less than the speed V1 to a value equal to or greater than the speed V1, the adaptive update process is started.

In a case where the vehicle speed V is equal to or greater than the speed V1 and less than the speed V2 in the table, the step size parameter μ becomes continuously smaller as the vehicle speed V decreases. Accordingly, as the vehicle speed V decreases, the update amount of the adaptive update filters W2, C\hat{ }2, H\hat{ }2 in the adaptive update process (the second term on the right-hand side of the above formulas (4) to (6): an example of a processing amount in the adaptive update process) decreases continuously.

In a case where the vehicle speed V is equal to or greater than the speed V2 and is less than a speed V3 (an example of a second speed) that is higher than the speed V2 in the μ table, the step size parameter μ is kept at the maximum value thereof. Accordingly, the update amount of the adaptive update filters W2, C\hat{ }2, H\hat{ }2 in the adaptive update process becomes the largest.

In a case where the vehicle speed V is equal to or greater than the speed V3 and is less than a speed V4 that is higher than the speed V3 in the μ table, the step size parameter μ becomes smaller as the vehicle speed V increases. Accordingly, as the vehicle speed V increases, the update amount of the adaptive update filters W2, C\hat{ }2, H\hat{ }2 in the adaptive update process decreases continuously.

In a case where the vehicle speed V is equal to or greater than the speed V4 in the μ table, the step size parameter μ is maintained at a constant value greater than 0 and less than the maximum value thereof. Accordingly, in a case where the vehicle speed V is equal to or greater than the speed V3 in the μ table, the step size parameter μ becomes smaller as compared to a case where the vehicle speed V is equal to or greater than the speed V2 and less than the speed V3. Accordingly, in a case where the vehicle speed V is equal to or greater than the speed V3, the update amount of the adaptive update filters W2, C\hat{ }2, H\hat{ }2 in the adaptive update process becomes smaller as compared to a case where the vehicle speed V is equal to or greater than the speed V2 and less than the speed V3.

### <η Table>

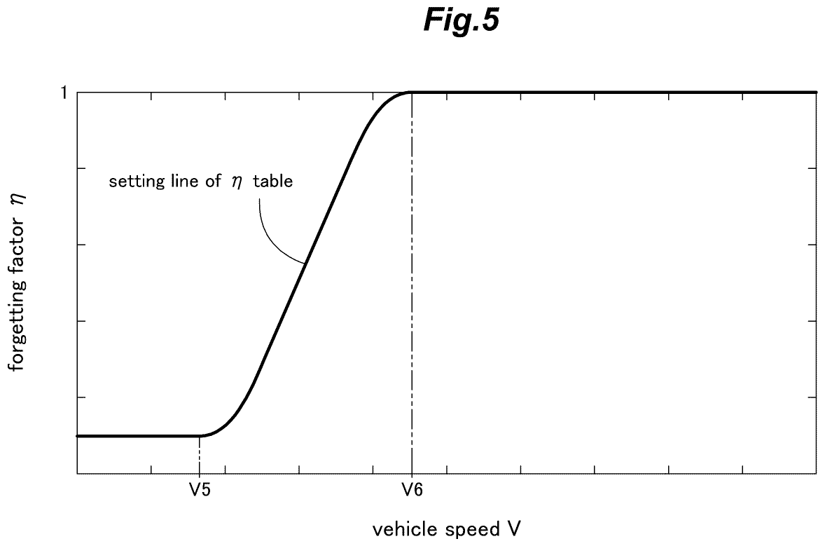

With reference to FIG. 5, in a case where the vehicle speed V is less than a speed V5 in the η table, the forgetting factor η is kept at the minimum value thereof. Accordingly, the reflection amount of the current value of the adaptive update filters W2, C\hat{ }2, H\hat{ }2 in the update value of the adaptive update filters W2, C\hat{ }2, H\hat{ }2 in the adaptive update process (the first term on the right-hand side of the above formulas (4) to (6): an example of a processing amount in the adaptive update process) becomes the smallest. Accordingly, the attenuation of the adaptive update filters W2, C\hat{ }2, H\hat{ }2 becomes the greatest.

In a case where the vehicle speed V is equal to or greater than the speed V5 and less than a speed V6 (an example of a reference speed) that is greater than the speed V5 in the η table, the forgetting factor η becomes smaller as the vehicle speed V decreases. Accordingly, as the vehicle speed V decreases, the reflection amount of the current value of the adaptive update filters W2, C\hat{ }2, H\hat{ }2 in the update value of the adaptive update filters W2, C\hat{ }2, H\hat{ }2 in the adaptive update process decreases continuously.

In a case where the vehicle speed V is equal to or greater than the speed V6 in the η table, the forgetting factor η is kept at 1. Accordingly, the reflection amount of the current value of the adaptive update filters W2, C\hat{ }2, H\hat{ }2 in the update value of the adaptive update filters W2, C\hat{ }2, H\hat{ }2 in the adaptive update process becomes the greatest. Accordingly, the attenuation of the adaptive update filters W2, C\hat{ }2, H\hat{ }2 becomes the smallest. The speed V6 in the η table is set lower than the speed V2 in the μ table.

### Effects

The noise d generated in the vehicle cabin 8 of the vehicle 3 includes the noise (the road noise) caused by the road surface vibrations and the aerodynamic noise. The controller 15 controls the speaker 12 based on the acceleration signal x. This effectively reduces the noise caused by the road surface vibrations. On the other hand, the aerodynamic noise may not be reduced sufficiently by simply controlling the speaker 12 based on the acceleration signal x. Thus, the controller 15 controls the speaker 12 based on both the acceleration signal x and the microphone signal m (more specifically, the reference signal r). Accordingly, it is possible to sufficiently reduce not only the noise caused by the road surface vibrations but also the aerodynamic noise.

The noise reduction device 1 is designed so that the control effect thereof gets higher in the vicinity of the microphone 13. Considering this, according to the present embodiment, the microphone 13 is installed in the headrest 9C of the occupant seat 9. This allows the head of the occupant to be brought closer to the microphone 13, thereby enhancing the control effect that the occupant can feel.

On the other hand, if the microphone 13 is installed in the headrest 9C of the occupant seat 9, the position of the microphone 13 changes significantly and thus the transfer function C of the secondary path from the speaker 12 to the microphone 13 changes significantly in a case where the front-and-rear position of the occupant seat 9 is adjusted or the seat back 9B of the occupant seat 9 is reclined. Accordingly, the difference between the transfer function C of the secondary path and the secondary path filter C\hat{ }1, C\hat{ }2 becomes large, and thus the noise reduction device 1 may not be able to sufficiently reduce the noise d, or the noise d may be amplified. Considering this, the controller 15 adaptively updates the secondary path filter C\hat{ }1, C\hat{ }2. Accordingly, in a case where the transfer function C of the secondary path changes, the secondary path filter C\hat{ }1, C\hat{ }2 can change according to the change in the transfer function C. Accordingly, the noise reduction device 1 can sufficiently reduce the noise d and suppress the amplification of the noise d.

By the way, when the microphone 13 is installed in the headrest 9C of the occupant seat 9, the microphone 13 gets closer to the mouth of the occupant, which makes it easier for the microphone 13 to pick up the conversation sound of the occupant. In other words, the sound component is more likely to mix into the microphone signal m. When the microphone signal m into which the sound component has mixed is used as the reference signal r, the control signal u is generated based on the reference signal r into which the sound component has mixed, and the sound component may also mix into the canceling sound y output based on the control signal u. Accordingly, an acoustic echo may occur in the vehicle cabin 8, which may cause discomfort of the occupant.

In this regard, when the vehicle speed V is high, the aerodynamic noise becomes louder. Even if the occupant talks in such a situation, the aerodynamic noise drowns out the conversation sound, and therefore an acoustic echo is unlikely to occur. On the other hand, when the vehicle speed V decreases, the aerodynamic noise decreases. If the occupant talks in such a situation, the conversation sound becomes louder relative to the aerodynamic noise, and therefore the acoustic echo is more likely to occur. Further, when the vehicle speed V is low, the aerodynamic noise is unlikely to occur, and therefore there is little need to control the speaker 12 based on the reference signal r to reduce the aerodynamic noise.

Accordingly, the controller 15 changes the update amount of the adaptive update filters W2, C\hat{ }2, H\hat{ }2 (the filters for controlling the speaker 12 based on the reference signal r) and the reflection amount of the current value of the adaptive update filters W2, C\hat{ }2, H\hat{ }2 in the update value of the adaptive update filters W2, C\hat{ }2, H\hat{ }2 according to the vehicle speed V. More specifically, in a case where the vehicle speed V is equal to or greater than the speed V1 and less than the speed V2, the controller 15 reduces the update amount of the adaptive update filters W2, C\hat{ }2, H\hat{ }2 as the vehicle speed V decreases. Further, in a case where the vehicle speed V is equal to or greater than the speed V5 and less than the speed V6, the controller 15 reduces the reflection amount of the current value of the adaptive update filters W2, C\hat{ }2, H\hat{ }2 in the update value of the adaptive update filters W2, C\hat{ }2, \hat{ }2 as the vehicle speed V decreases. Accordingly, when the vehicle speed V is low (when the conversation sound becomes louder relative to the aerodynamic noise), it is possible to suppress the occurrence of the acoustic echo by reducing the update amount and the reflection amount of the adaptive update filters W2, C\hat{ }2, H\hat{ }2. On the other hand, when the vehicle speed V is high (when the aerodynamic noise becomes louder relative to the conversation sound), it is possible to suppress the aerodynamic noise by increasing the update amount and the reflection amount of the adaptive update filters W2, C\hat{ }2, H\hat{ }2. In other words, it is possible to ensure the reduction effect of the aerodynamic noise when the vehicle speed V is high while suppressing the occurrence of the acoustic echo when the vehicle speed V is low.

### Modified Embodiments

In the above embodiment, the controller 15 changes the processing amount in the adaptive update process in the second control signal generation unit 18 and the second sound field learning unit 19 (examples of the second controller). In another embodiment, the controller 15 may change the processing amount in the adaptive update process in the first control signal generation unit 16 and the first sound field learning unit 17 (examples of the first controller), or may change both the processing amount in the adaptive update process in the second control signal generation unit 18 and the second sound field learning unit 19 and the processing amount in the adaptive update process in the first control signal generation unit 16 and the first sound field learning unit 17.

In the above embodiment, the controller 15 adaptively updates the adaptive update filters W2, C\hat{ }2, H\hat{ }2 using the above formulas (4) to (6). However, the above formulas (4) to (6) are merely examples of formulas used for the adaptive update of the adaptive update filters W2, C\hat{ }2, H\hat{ }2. According to another embodiment, the controller 15 may adaptively update the adaptive update filters W2, C\hat{ }2, H\hat{ }2 using formulas other than the above formulas (4) to (6). For example, the controller 15 may use the following formulas (7) to (9) instead of the above formulas (4) to (6) (details are omitted, but similar substitutions are possible for the above formulas (1) to (3)).

$$W 2 ( t + 1 ) = η W 2 ( t ) - {μ}_{W} ( t ) e ( t ) ( r ( t ) * \hat{C} 2 ( t ) ) \qquad ( 7 )$$

$$\hat{C} 2 ( t + 1 ) = η \hat{C} 2 ( t ) + {μ}_{HC} ( t ) {e}_{v} 2 ( t ) ( r ( t ) * W 2 ( t ) ) \qquad ( 8 )$$

$$\hat{H} 2 ( t + 1 ) = η \hat{H} 2 ( t ) + {μ}_{HC} ( t ) {e}_{v} 2 ( t ) r ( t ) \qquad ( 9 )$$

μ_{w}(t) in the above formula (7) is represented by the following formula (10), and μ_{HC}(t) in the above formulas (8) and (9) is represented by the following formula (11).

$${μ}_{W} ( t ) = μ \frac{\vert {ρ}_{W} ( t ) \vert + β}{‖ r ( t ) * \hat{C} 2 ( t ) ‖ + σ} \qquad ( 10 )$$

$${μ}_{HC} ( t ) = μ \frac{\vert {ρ}_{HC} ( t ) \vert + β}{‖ r ( t ) ‖ + ‖ r ( t ) * W 2 ( t ) ‖ + σ} \qquad ( 11 )$$

“β” and “σ” in the above formulas (10) and (11) represent small positive numbers. ρ_{w}(t) in the above formula (10) is represented by the following formula (12), and ρ_{HC}(t) in the above formula (11) is represented by the following formula (13).

$${ρ}_{W} ( t ) = {λρ}_{W} ( t ) + ( 1 - λ ) {e ( t )}^{2} \qquad ( 12 )$$

$${ρ}_{HC} ( t ) = {λρ}_{HC} ( t ) + ( 1 - λ ) {e}_{v} 2 {( t )}^{2} \qquad ( 13 )$$

In the above embodiment, the controller 15 uses the current value (W 2(t), C\hat{ }2(t), H\hat{ }2(t)) of the adaptive update filters W2, C\hat{ }2, H\hat{ }2 as the value of the adaptive update filters W2, C\hat{ }2, H\hat{ }2 before the adaptive update thereof. In another embodiment, the controller 15 may use the past value of the adaptive update filters W2, C\hat{ }2, H\hat{ }2 (for example, W2(t−1), C\hat{ }2(t−1), H\hat{ }2(t−1)) as the value of the adaptive update filters W2, C\hat{ }2, H\hat{ }2 before the adaptive update thereof, or may use both the current value and the past value of the adaptive update filters W2, C\hat{ }2, H\hat{ }2 (the same applies to the control filter W1, the secondary path filter C\hat{ }1, and the primary path filter H\hat{ }1).

In the above embodiment, the controller 15 includes a plurality of adaptive update filters W2, C\hat{ }2, H\hat{ }2. In another embodiment, the controller 15 may include only one adaptive update filter.

In the above embodiment, both the acceleration signal x and the microphone signal m are used as the reference signal. In another embodiment, only one of the acceleration signal x and the microphone signal m may be used as the reference signal.

In the above embodiment, the noise reduction device 1 is applied to the vehicle cabin 8 of the vehicle 3. In another embodiment, the noise reduction device 1 may be applied to the interior space of a mobile body other than the vehicle 3 (for example, a ship or an aircraft).

This concludes the description of the specific embodiments, but the present invention is not limited to the above embodiments or modified embodiments, and can be widely modified and implemented.

### Summary of Embodiment

According to one aspect, an active noise reduction device 1 used for a mobile body 3 comprises: a canceling sound outputter 12 configured to output a canceling sound y for canceling a noise d; and a controller 15 configured to control the canceling sound outputter 12, wherein the controller 15 includes at least one filter W2, C\hat{ }2, H\hat{ }2 that can be adaptively updated, and the controller 15 is configured to change a processing amount in an adaptive update process of the filter W2, C\hat{ }2, H\hat{ }2 according to a speed V of the mobile body 3.

According to this aspect, by changing the processing amount in the adaptive update process according to the speed V of the mobile body 3, it is possible to stably and effectively reduce the noise d.

Preferably, the active noise reduction device 1 further comprises: an acceleration sensor 11 configured to generate an acceleration signal x based on the noise d; and a microphone 13 configured to generate a microphone signal m based on the noise d, wherein the controller 15 includes: a first controller 16, 17 to which the acceleration signal x is input as a reference signal r corresponding to the noise d; and a second controller 18, 19 to which the microphone signal m is input as the reference signal r, and the controller 15 is configured to change the processing amount in the adaptive update process in the second controller 18, 19 according to the speed V of the mobile body 3.

According to this aspect, it is possible to not only reduce the noise related to the road surface vibrations based on the acceleration signal x but also reduce the aerodynamic noise based on the microphone signal m. In other words, it is possible to reduce both the noise related to the road surface vibrations and the aerodynamic noise. Further, by changing the processing amount in the adaptive update process in the second controller 18, 19 (the controller to which the microphone signal m is input) according to the speed V of the mobile body 3, it is possible to suppress the occurrence of the acoustic echo.

Preferably, in a case where the speed V of the mobile body 3 is less than a first speed V2, the controller 15 is configured to reduce an update amount of the filter W2, C\hat{ }2, H\hat{ }2 in the adaptive update process in the second controller 18, 19 as the speed V of the mobile body 3 decreases.

According to this aspect, when the speed V of the mobile body 3 is low (when the conversation sound is louder relative to the aerodynamic noise), it is possible to suppress the occurrence of the acoustic echo by reducing the update amount of the filter W2, C\hat{ }2, H\hat{ }2 in the adaptive update process in the second controller 18, 19 (the controller to which the microphone signal m is input). On the other hand, when the speed V of the mobile body 3 is high (when the aerodynamic noise is louder relative to the conversation sound), it is possible to suppress the aerodynamic noise by increasing the update amount of the filter W2, C\hat{ }2, H\hat{ }2 in the adaptive update process in the second controller 18, 19. That is, it is possible to suppress the occurrence of the acoustic echo when the speed V of the mobile body 3 is low while ensuring the reduction effect of the aerodynamic noise when the speed V of the mobile body 3 is high.

Preferably, in a case where the speed V of the mobile body 3 is less than a reference speed V6, the controller 15 is configured to reduce a reflection amount of a value of the filter W2, C\hat{ }2, H\hat{ }2 before an adaptive update thereof in a value of the filter W2, C\hat{ }2, H\hat{ }2 after the adaptive update thereof in the adaptive update process in the second controller 18, 19 as the speed V of the mobile body 3 decreases.

According to this aspect, when the speed V of the mobile body 3 is low (when the conversation sound is louder relative to the aerodynamic noise), it is possible to suppress the occurrence of the acoustic echo by reducing the reflection amount in the adaptive update process in the second controller 18, 19 (the controller to which the microphone signal m is input). On the other hand, when the speed V of the mobile body 3 is high (when the aerodynamic noise is louder relative to the conversation sound), it is possible to suppress the aerodynamic noise by increasing the reflection amount in the adaptive update process in the second controller 18, 19. That is, it is possible to suppress the occurrence of the acoustic echo when the speed V of the mobile body 3 is low while ensuring the reduction effect of the aerodynamic noise when the speed V of the mobile body 3 is high.

Preferably, the controller 15 is configured to change an update amount of the filter W2, C\hat{ }2, H\hat{ }2 in the adaptive update process according to the speed V of the mobile body 3.

According to this aspect, by changing the update amount of the filter W2, C\hat{ }2, H\hat{ }2 in the adaptive update process according to the speed V of the mobile body 3, it is possible to more stably and effectively reduce the noise d.

Preferably, in a case where the speed V of the mobile body 3 is less than a first speed V2, the controller 15 is configured to reduce the update amount as the speed V of the mobile body 3 decreases.

According to this aspect, when the speed V of the mobile body 3 is low (when the conversation sound is louder relative to the aerodynamic noise), it is possible to prevent the update amount of the filter W2, C\hat{ }2, H\hat{ }2 from becoming excessive, thereby improving the stability of control.

Preferably, in a case where the speed V of the mobile body 3 is equal to or greater than a second speed V3 that is higher than the first speed V2, the controller 15 is configured to reduce the update amount as compared to a case where the speed V of the mobile body 3 is equal to or greater than the first speed V2 and less than the second speed V3.

According to this aspect, when the speed V of the mobile body 3 is high (when the aerodynamic noise is louder relative to the conversation sound), it is possible to prevent the update amount of the filter W2, C\hat{ }2, H\hat{ }2 from becoming excessive, thereby improving the stability of control.

Preferably, the controller 15 is configured to change a reflection amount of a value of the filter W2, C\hat{ }2, H\hat{ }2 before an adaptive update thereof in a value of the filter W2, C\hat{ }2, H\hat{ }2 after the adaptive update thereof in the adaptive update process according to the speed V of the mobile body 3.

According to this aspect, by changing the reflection amount in the adaptive update process according to the speed V of the mobile body 3, it is possible to more stably and effectively reduce the noise d.

Preferably, in a case where the speed V of the mobile body 3 is less than a reference speed V6, the controller 15 is configured to reduce the reflection amount as the speed V of the mobile body 3 decreases.

According to this aspect, when the speed V of the mobile body 3 is low (when the conversation sound is louder relative to the aerodynamic noise), it is possible to prevent the canceling sound y (control output) from becoming excessive.

Preferably, the controller 15 is configured to: reduce an update amount of the filter W2, C\hat{ }2, H\hat{ }2 in the adaptive update process as the speed V of the mobile body 3 decreases in a case where the speed V of the mobile body 3 is less than a first speed V2; and set the reference speed V6 lower than the first speed V2.

According to this aspect, as the speed V of the mobile body 3 increases, the speed V of the mobile body 3 first reaches the reference speed V6, and then the speed V of the mobile body 3 reaches the first speed V2. Accordingly, the reflection amount in the adaptive update process first reaches the maximum value thereof, and then the update amount in the adaptive update process reaches the maximum value thereof. Accordingly, it is possible to improve the update speed (update efficiency) of the adaptive update process.

1. An active noise reduction device used for a mobile body, the active noise reduction device comprising:
a canceling sound outputter configured to output a canceling sound for canceling a noise; and
a controller configured to control the canceling sound outputter,
wherein the controller includes at least one filter that can be adaptively updated, and
the controller is configured to change a processing amount in an adaptive update process of the filter according to a speed of the mobile body.

2. The active noise reduction device according to claim 1, further comprising:
an acceleration sensor configured to generate an acceleration signal based on the noise; and
a microphone configured to generate a microphone signal based on the noise,
wherein the controller includes:
a first controller to which the acceleration signal is input as a reference signal corresponding to the noise; and
a second controller to which the microphone signal is input as the reference signal, and
the controller is configured to change the processing amount in the adaptive update process in the second controller according to the speed of the mobile body.

3. The active noise reduction device according to claim 2, wherein in a case where the speed of the mobile body is less than a first speed, the controller is configured to reduce an update amount of the filter in the adaptive update process in the second controller as the speed of the mobile body decreases.

4. The active noise reduction device according to claim 2, wherein in a case where the speed of the mobile body is less than a reference speed, the controller is configured to reduce a reflection amount of a value of the filter before an adaptive update thereof in a value of the filter after the adaptive update thereof in the adaptive update process in the second controller as the speed of the mobile body decreases.

5. The active noise reduction device according to claim 1, wherein the controller is configured to change an update amount of the filter in the adaptive update process according to the speed of the mobile body.

6. The active noise reduction device according to claim 5, wherein in a case where the speed of the mobile body is less than a first speed, the controller is configured to reduce the update amount as the speed of the mobile body decreases.

7. The active noise reduction device according to claim 6, wherein in a case where the speed of the mobile body is equal to or greater than a second speed that is higher than the first speed, the controller is configured to reduce the update amount as compared to a case where the speed of the mobile body is equal to or greater than the first speed and less than the second speed.

8. The active noise reduction device according to claim 1, wherein the controller is configured to change a reflection amount of a value of the filter before an adaptive update thereof in a value of the filter after the adaptive update thereof in the adaptive update process according to the speed of the mobile body.

9. The active noise reduction device according to claim 8, wherein in a case where the speed of the mobile body is less than a reference speed, the controller is configured to reduce the reflection amount as the speed of the mobile body decreases.

10. The active noise reduction device according to claim 9, wherein the controller is configured to:
reduce an update amount of the filter in the adaptive update process as the speed of the mobile body decreases in a case where the speed of the mobile body is less than a first speed; and
set the reference speed lower than the first speed.
